(19) United States
(12) Patent Application Publication
(10) Pub. No.: US 2018/0069323 A1
(43) Pub. Date: Mar. 8, 2018

(54) COMMUNICATION APPARATUS

(71) Applicant: KYOCERA CORPORATION, Kyoto (JP)

(72) Inventors: Fangwei TONG, Tokyo (JP); Chiharu YAMAZAKI, Tokyo (JP); Atsuhisa INAKOSHI, Yokohama-shi (JP)

(73) Assignee: KYOCERA CORPORATION, Kyoto (JP)

(21) Appl. No.: 15/811,891

(22) Filed: Nov. 14, 2017

Related U.S. Application Data
(63) Continuation of application No. PCT/JP2016/064014, filed on May 11, 2016.
(60) Provisional application No. 62/162,257, filed on May 15, 2015.

(51) Int. Cl. H01Q 21/06; H04L 5/00

(52) U.S. Cl. CPC H01Q 21/064; H04W 16/28; H04L 5/0048

(57) ABSTRACT

A communication apparatus according to one embodiment comprises an antenna array having antenna elements arranged in rows and columns, and a transmitter configured to simultaneously use specific antenna elements that are some antenna elements out of all antenna elements of the antenna array to transmit a reference signal. At least one of the specific antenna elements is arranged in each row and each column of the antenna array.

### CROSS-REFERENCE TO RELATED APPLICATION

The present application is a continuation based on PCT Application No. PCT/JP2016/064014 filed on May 11, 2016, which claims the benefit of U.S. Provisional Application No. 62/162,257 (filed on May 15, 2015). The content of which is incorporated by reference herein in their entirety.

### FIELD

The present application relates to a communication apparatus used in a radio communication system.

### BACKGROUND

In 3GPP (Third Generation Partnership Project) which is a project aiming to standardize a radio communication system, an introduction of a multi-antenna transmission scheme (2-Dimension antenna array system) using an antenna array having antenna elements arranged in rows and columns has been discussed. The antenna elements included in such antenna array may be referred to as an “antenna port” or a “TXRU (Transceiver Unit)”.

### SUMMARY

A communication apparatus according to one embodiment comprises an antenna array having antenna elements arranged in rows and columns, and a transmitter configured to simultaneously use specific antenna elements that are some antenna elements out of all antenna elements of the antenna array to transmit a reference signal. At least one of the specific antenna elements is arranged in each row and each column of the antenna array.

### BRIEF DESCRIPTION OF THE DRAWINGS

FIG. 1 is a diagram illustrating a configuration of an LTE system (radio communication system).

FIG. 2 is a block diagram of an eNB (base station).

FIG. 3 is a block diagram of a UE (radio terminal).

FIG. 4 is a protocol stack diagram of a radio interface in the LTE system.

FIG. 5 is a configuration diagram of a radio frame used in the LTE system.

FIG. 6 is a diagram for describing an overview of downlink multi-antenna transmission.

FIG. 7 is a diagram illustrating an antenna array according to a first embodiment to a third embodiment.

FIG. 8A illustrates another configuration example 1 of the antenna array, and FIG. 8B illustrates another configuration example 2 of the antenna array.

FIG. 9A is a diagram illustrating a comparative example 1, and FIG. 9B is a diagram illustrating a comparative example 2.

FIG. 10 is a diagram illustrating an example of an operation sequence according to the first embodiment.

FIG. 11 is a diagram illustrating an example of an operation sequence according to the second embodiment.

FIGS. 12A and 12B are diagrams for describing an example of complementing processing.

FIG. 13 is a diagram illustrating an example of an operation sequence according to the third embodiment.

FIG. 14 is a diagram illustrating a mapping option between a CSI-RS port and a TXRU according to the additional mark.

FIG. 15A is a diagram illustrating a CSI-RS port mapping (before shift) for a horizontal channel measurement according to the additional mark. FIG. 15B is a diagram illustrating a CSI-RS port mapping (after shift) for the horizontal channel measurement according to the additional mark.

FIG. 16A is a diagram illustrating a CSI-RS port mapping (before shift) for a vertical channel measurement according to the additional mark. FIG. 16B is a diagram illustrating a CSI-RS port mapping (after shift) for the vertical channel measurement according to the additional mark.

FIG. 17 is a diagram illustrating a “new” CSI-RS port mapping pattern according to the additional mark.

### DESCRIPTION OF THE EMBODIMENT

### Overview of Embodiments

A communication apparatus (e.g., base station) according to first to third embodiments comprises an antenna array having antenna elements arranged in rows and columns, and a transmitter configured to simultaneously use specific antenna elements that are some antenna elements out of all antenna elements of the antenna array to transmit a reference signal. At least one of the specific antenna elements is arranged in each row and each column of the antenna array.

In the first to third embodiment, only some antenna elements in each row of the antenna array are the specific antenna elements, and only some antenna elements in each column of the antenna array are the specific antenna elements.

In the first to third embodiment, the specific antenna elements are arranged on a diagonal line of the antenna array.

In the second embodiment, the communication apparatus comprises a receiver configured to receive feedback information from another communication apparatus, and a controller configured to perform complementing processing, based on the feedback information. The feedback information is information corresponding to channel characteristics estimated by the other communication apparatus for each of the specific antenna elements by using the reference signal. The complementing processing is processing of complementing channel characteristics corresponding to an antenna element other than the specific antenna elements in the antenna array.

In the second embodiment, the controller performs the complementing processing, based on the feedback information fed back one time for one transmission of the reference signal.

A communication apparatus (e.g., radio terminal) according to the third embodiment comprises a receiver configured to receive a reference signal transmitted from another communication apparatus having an antenna array, and a controller configured to use the reference signal to estimate channel characteristics for each of specific antenna elements. The specific antenna elements are some antenna elements out of all antenna elements of the antenna array, and at least one of the specific antenna elements is arranged in each row and each column of the antenna array. The other communication apparatus simultaneously uses the specific antenna elements to transmit the reference signal. The controller performs complementing processing for complementing channel characteristics corresponding to an antenna element other than the specific antenna elements in the antenna array to generate feedback information for the other communication apparatus.

In the third embodiment, the controller performs the complementing processing one time for one transmission of the reference signal.

In the third embodiment, the controller obtains information on the antenna array from the other communication apparatus, and uses the obtained information to perform the complementing processing.

A communication apparatus (e.g., base station) according to the third embodiment comprises an antenna array having antenna elements arranged in rows and columns, a transmitter configured to simultaneously use specific antenna elements that are some antenna elements out of all antenna elements of the antenna array to transmit a reference signal, and a controller configured to notify another communication apparatus of information on the antenna array. The information on the antenna array includes at least one of information indicating a physical amount of the antenna array and information indicating the location of each of the specific antenna ports.

### First Embodiment

(Configuration of Radio Communication System)

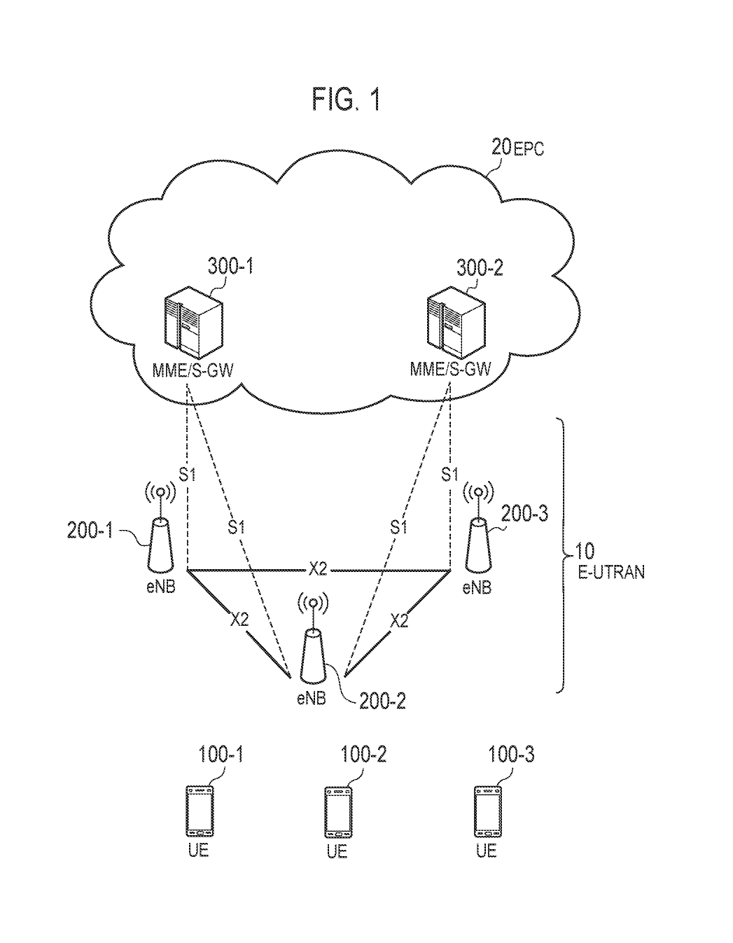

FIG. 1 is a diagram illustrating a configuration of a LTE system that is a radio communication system according to the first embodiment. As illustrated in FIG. 1, the LTE system includes a plurality of UEs (User Equipments) 100, E-UTRAN (Evolved-UMTS Terrestrial Radio Access Network) 10, and EPC (Evolved Packet Core) 20.

The UE 100 corresponds to a radio terminal. The UE 100 is a mobile communication device and performs radio communication with a eNB 200.

The E-UTRAN 10 corresponds to a radio access network. The E-UTRAN 10 includes a plurality of eNBs (evolved Node-Bs) 200. The eNB 200 corresponds to a base station. The eNBs 200 are connected mutually via an X2 interface.

The eNB 200 manages one or a plurality of cells and performs radio communication with the UE 100 which establishes a connection with the cell of the eNB 200. The eNB 200 has a radio resource management (RRM) function, a routing function for user data (hereinafter simply referred as “data”), and a measurement control function for mobility control and scheduling, and the like. It is noted that the “cell” is used as a term indicating a minimum unit of a radio communication area, and is also used as a term indicating a function of performing radio communication with the UE 100.

The EPC 20 corresponds to a core network. The EPC 20 includes a plurality of MME (Mobility Management Entity)/S-GWs (Serving-Gateways) 300. The MME performs various mobility controls and the like for the UE 100. The S-GW performs control to transfer data. MME/S-GW 300 is connected to eNB 200 via an Si interface. The E-UTRAN 10 and the EPC 20 constitute a network.

(Configuration of Base Station)

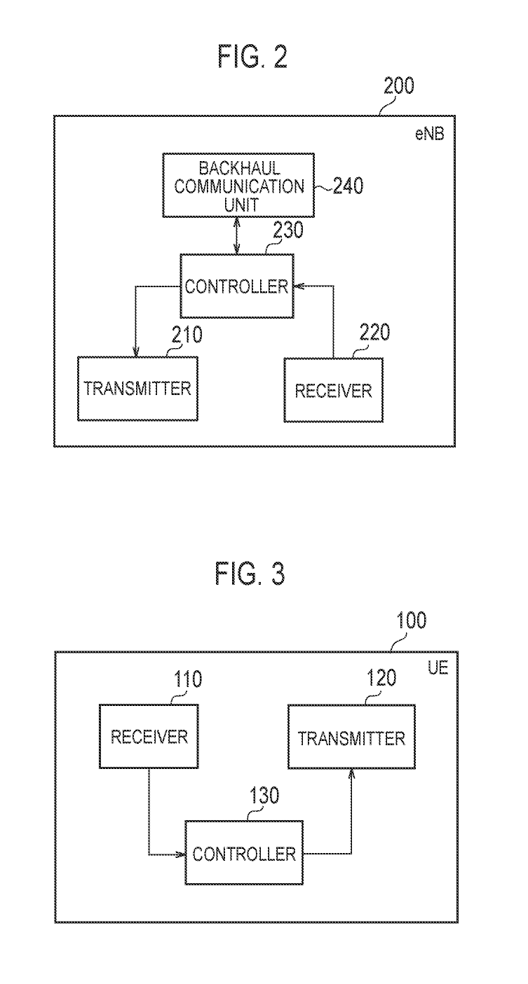

FIG. 2 is a block diagram of the eNB 200 (base station). As illustrated in FIG. 2, the eNB 200 includes: a transmitter 210, a receiver 220, a controller 230, and a backhaul communication unit 240.

The transmitter 210 performs various types of transmissions under the control of the controller 230. The transmitter 210 includes an antenna and a transmitter unit. The transmitter unit converts a baseband signal (transmitted signal) output from the controller 230 into a radio signal, and transmits the radio signal from the antenna. The receiver 220 performs various types of receptions under the control of the controller 230. The receiver 220 includes an antenna and a receiver unit. The receiver unit converts a radio signal received by the antenna into a baseband signal (received signal), and outputs the baseband signal to the controller 230.

Antenna provided in the eNB 200 is an antenna array 250 (not shown in FIG. 2, see FIG. 7) having antenna ports (antenna elements) arranged in rows and columns.

The controller 230 performs various types of controls in the eNB 200. The controller 230 includes a processor and a memory. The memory stores a program to be executed by the processor, and information to be utilized for a process by the processor. The processor includes a baseband processor that performs modulation and demodulation, encoding and decoding and the like of a baseband signal, and a CPU (Central Processing Unit) that performs various processes by executing the program stored in the memory. The processor executes the above-described processes and below-described processes.

The backhaul communication unit 240 is connected to a neighboring eNB 200 via the X2 interface and is connected to the MME/S-GW 300 via the S1 interface. The backhaul communication unit 240 is used for communication performed on the X2 interface, communication performed on the S1 interface, and the like.

(Configuration of Radio Terminal)

FIG. 3 is a block diagram of the UE 100 (radio terminal). As illustrated in FIG. 3, the UE 100 includes: a receiver 110, a transmitter 120, and a controller 130.

The receiver 110 performs various types of receptions under the control of the controller 130. The receiver 110 includes an antenna and a receiver unit. The receiver unit converts a radio signal received by the antenna into a baseband signal (received signal), and outputs the baseband signal to the controller 130. The transmitter 120 performs various types of transmissions under the control of the controller 130. The transmitter 120 includes an antenna and a transmitter unit. The transmitter unit converts a baseband signal (transmitted signal) output from the controller 130 into a radio signal, and transmits the radio signal from the antenna.

The controller 130 performs various types of controls in the UE 100. The controller 130 includes a processor and a memory. The memory stores a program to be executed by the processor, and information to be utilized for a process by the processor. The processor includes a baseband processor that performs modulation and demodulation, encoding and decoding and the like of a baseband signal, and a CPU (Central Processing Unit) that performs various processes by executing the program stored in the memory. The processor may include a codec that performs encoding and decoding on sound and video signals. The processor executes the above-described processes and below-described processes.

(Configuration of Radio Interface)

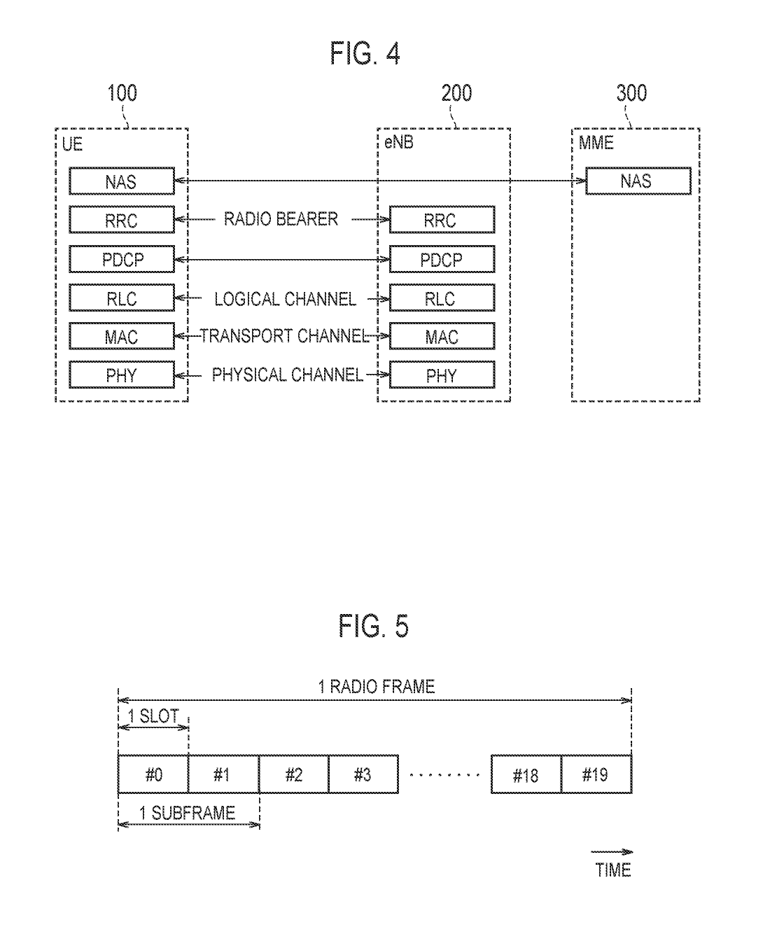

FIG. 4 is a protocol stack diagram of a radio interface in the LTE system. As illustrated in FIG. 4, the radio interface protocol is classified into a layer 1 to a layer 3 of an OSI reference model, wherein the layer 1 is a physical (PHY) layer. The layer 2 includes a MAC (Medium Access Control) layer, an RLC (Radio Link Control) layer, and a PDCP (Packet Data Convergence Protocol) layer. The layer 3 includes an RRC (Radio Resource Control) layer.

The PHY layer performs encoding and decoding, modulation and demodulation, antenna mapping and demapping, and resource mapping and demapping. Between the PHY layer of the UE 100 and the PHY layer of the eNB 200, data and control information are transmitted via the physical channel.

The MAC layer performs priority control of data, a retransmission process by hybrid ARQ (HARQ), and a random access procedure and the like. Between the MAC layer of the UE 100 and the MAC layer of the eNB 200, data and control signal are transmitted via a transport channel. The MAC layer of the eNB 200 includes a scheduler that determines a transport format of an uplink and a downlink (a transport block size and a modulation and coding scheme (MCS)) and a resource block to be assigned to the UE 100.

The RLC layer transmits data to an RLC layer of a reception side by using the functions of the MAC layer and the PHY layer. Between the RLC layer of the UE 100 and the RLC layer of the eNB 200, data and control signal are transmitted via a logical channel.

The PDCP layer performs header compression and decompression, and encryption and decryption.

The RRC layer is defined only in a control plane dealing with control signal. Between the RRC layer of the UE 100 and the RRC layer of the eNB 200, message (RRC messages) for various types of configuration are transmitted. The RRC layer controls the logical channel, the transport channel, and the physical channel in response to establishment, re-establishment, and release of a radio bearer. When there is a connection (RRC connection) between the RRC of the UE 100 and the RRC of the eNB 200, the UE 100 is in an RRC connected mode, otherwise the UE 100 is in an RRC idle mode.

A NAS (Non-Access Stratum) layer positioned above the RRC layer performs a session management, a mobility management and the like.

(Overview of Lower Layer of LTE)

FIG. 5 is a configuration diagram of a radio frame used in the LTE system. In the LTE system, OFDMA (Orthogonal Frequency Division Multiplexing Access) is applied to a downlink, and SC-FDMA (Single Carrier Frequency Division Multiple Access) is applied to an uplink, respectively.

As illustrated in FIG. 5, a radio frame is configured by 10 subframes arranged in a time direction. Each subframe is configured by two slots arranged in the time direction. Each subframe has a length of 1 ms and each slot has a length of 0.5 ms. Each subframe includes a plurality of resource blocks (RBs) in a frequency direction (not shown), and a plurality of symbols in the time direction. Each resource block includes a plurality of subcarriers in the frequency direction. One symbol and one subcarrier forms one resource element. Of the radio resources (time and frequency resources) assigned to the UE 100, a frequency resource can be identified by a resource block and a time resource can be identified by a subframe (or a slot).

In the downlink, a section of several symbols at the head of each subframe is a region used as a physical downlink control channel (PDCCH) for mainly transmitting control signal. The details of the PDCCH will be described later. Furthermore, the other portion of each subframe is a region available as a physical downlink shared channel (PDSCH) for mainly transmitting downlink data.

In general, the eNB 200 uses the PDCCH to transmit downlink control signal (DCI) to the UE 100, and uses the PDSCH to transmit the downlink data to the UE 100. The downlink control signal carried by the PDCCH includes uplink scheduling information (SI), downlink SI, and a TPC bit. The uplink SI is scheduling information related to an allocation of an uplink radio resource (UL grant), and the downlink SI is scheduling information related to an allocation of a downlink radio resource. The TPC bit is information for instructing an increase or decrease in the uplink transmission power. In order to identify a UE 100 to which the downlink control signal is transmitted, the eNB 200 includes, into the downlink control information, a CRC bit scrambled by an identifier (RNTI: Radio Network Temporary ID) of the UE 100 to which the downlink control signal is transmitted. Each UE 100 descrambles, by the RNTI of the UE 100, the CRC bit of the downlink control signal that may be addressed to the UE 100 so as to perform blind decoding of the PDCCH to detect the downlink control signal addressed to the UE 100. The PDSCH carries the downlink data by the downlink radio resource (resource block) indicated by the downlink SI.

In the uplink, both ends in the frequency direction of each subframe are control regions used as a physical uplink control channel (PUCCH) for mainly transmitting an uplink control signal. Furthermore, the other portion of each subframe is a region available as a physical uplink shared channel (PUSCH) for mainly transmitting uplink data.

In general, the UE 100 uses the PUCCH to transmit uplink control signal (UCI: uplink control information) to the eNB 200, and uses the PUSCH to transmit the uplink data to the eNB 200. The uplink control signal carried by the PUCCH includes a CQI (Channel Quality Indicator), a PMI (Precoding Matrix Indicator), an RI (Rank Indicator), a scheduling request (SR), and a HARQ ACK/NACK. The CQI is an index indicating a downlink channel quality and is used for deciding an MCS to be used for the downlink transmission, for example. The PMI is an index indicating a precoder matrix desirably used for the downlink transmission. The RI is an index indicating the number of layers (the number of streams) available for the downlink transmission. The SR is information for requesting an allocation of a PUSCH resource. The HARQ ACK/NACK is delivery acknowledgment information indicating whether or not the downlink data is correctly received.

(Overview of Downlink Multi-antenna Transmission)

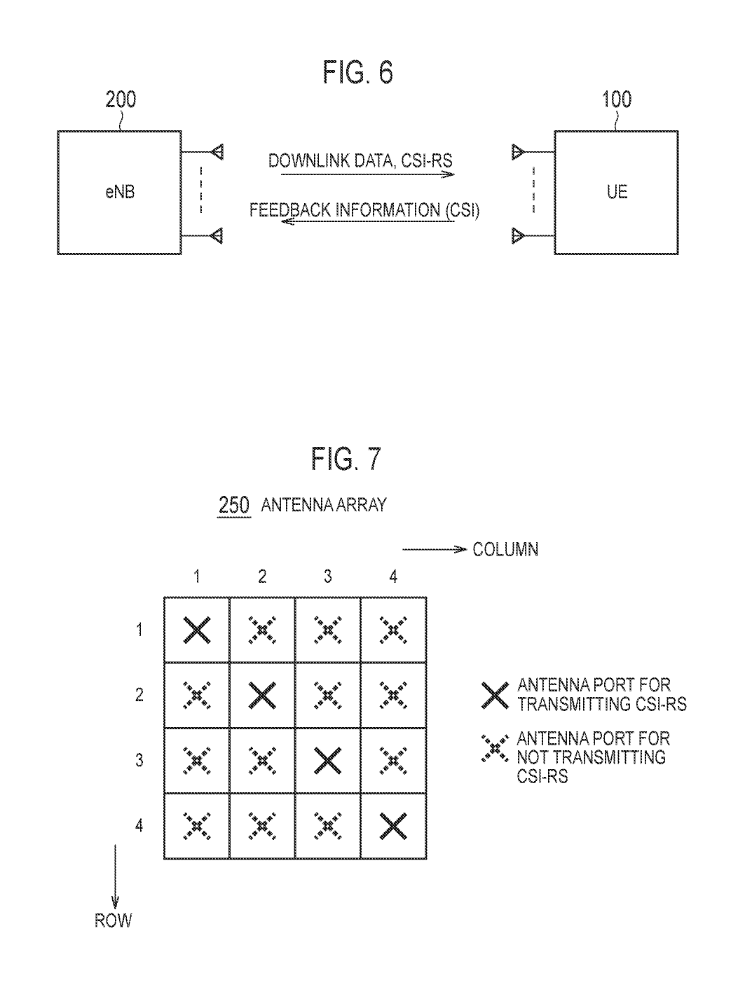

The LTE system supports downlink multi-antenna transmission. FIG. 6 is a diagram for describing an overview of downlink multi-antenna transmission.

As illustrated in FIG. 6, the eNB 200 has a plurality of transmission antenna ports, and the UE 100 has a plurality of reception antenna ports. However, the UE 100 may only have one reception antenna port. The eNB 200 uses the plurality of transmission antenna ports to transmit downlink data to the UE 100.

The eNB 200 uses an identical radio resource (time-frequency resource) to transmit a plurality of modulation symbol sequences to one UE 100 by SDM (Spatial Division Multiplexing). Such scheme is referred to as SU-MIMO (Single-User MIMO).

Alternatively, the eNB 200 uses the identical radio resource (time-frequency resource) to transmit a plurality of modulation symbol sequences to different UEs 100 by the SDM. Such scheme is referred to as MU-MIMO (Multi-User MIMO).

The eNB 200 transmits a reference signal of which the channel can be estimated from each transmission antenna port. Such reference signal is referred to as CSI-RS (Channel State Information-Reference Signal).

The UE 100 estimates the channel based on the CSI-RS received from the eNB 200, and estimates channel characteristics of each transmission antenna port. The UE 100 generates feedback information (CSI) indicating a channel state based on the channel estimation result, and feeds the generated CSI back to the eNB 200. The CSI is at least one of CQI, PMI, or RI. In the embodiment below, an example in which the CSI is mainly the PMI will be described.

The eNB 200 controls the downlink multi-antenna transmission, based on the CSI fed back from the UE 100.

(Antenna Array According to First Embodiment)

The eNB 200 according to the first embodiment includes an antenna array 250. FIG. 7 is a diagram illustrating the antenna array 250 according to the first embodiment.

As illustrated in FIG. 7, the antenna array 250 has an antenna port arranged in rows and columns. FIG. 7 exemplifies the antenna array 250 having four rows and four columns. Hereinafter, an antenna port of Mth row and Nth column will be noted as “antenna port (M, N)”.

In an actual operation environment, the antenna array 250 is arranged in the eNB 200, so that a row direction of the antenna array 250 matches the horizontal direction, and a column direction of the antenna array 250 matches the vertical direction. With such antenna array 250, it is possible to control a directional pattern not only in the horizontal direction but also in the vertical direction.

However, the antenna array 250 has a large number of antenna ports, and thus, transmitting a CSI-RS from all antenna ports causes an increase in overhead and processing complexity. Thus, the antenna array 250 according to the first embodiment simultaneously uses only some antenna ports of all antenna ports of the antenna array 250 to transmit a CSI-RS. Hereinafter, some antenna ports for transmitting a CSI-RS are referred to as “specific antenna ports (specific antenna elements)”.

In the first embodiment, at least one specific antenna port is arranged in each row and each column of the antenna array 250. Specifically, only some antenna ports in each row of the antenna array 250 are the specific antenna ports, and only some antenna ports in each column of the antenna array 250 are the specific antenna ports.

In FIG. 7, the specific antenna port is arranged on a diagonal line of the antenna array 250. Specifically, an antenna port (1, 1), an antenna port (2, 2), an antenna port (3, 3), and an antenna port (4, 4) are the specific antenna ports. However, an antenna port (1, 4), an antenna port (2, 3), an antenna port (3, 2), and an antenna port (4, 1) may be considered as the specific antenna ports.

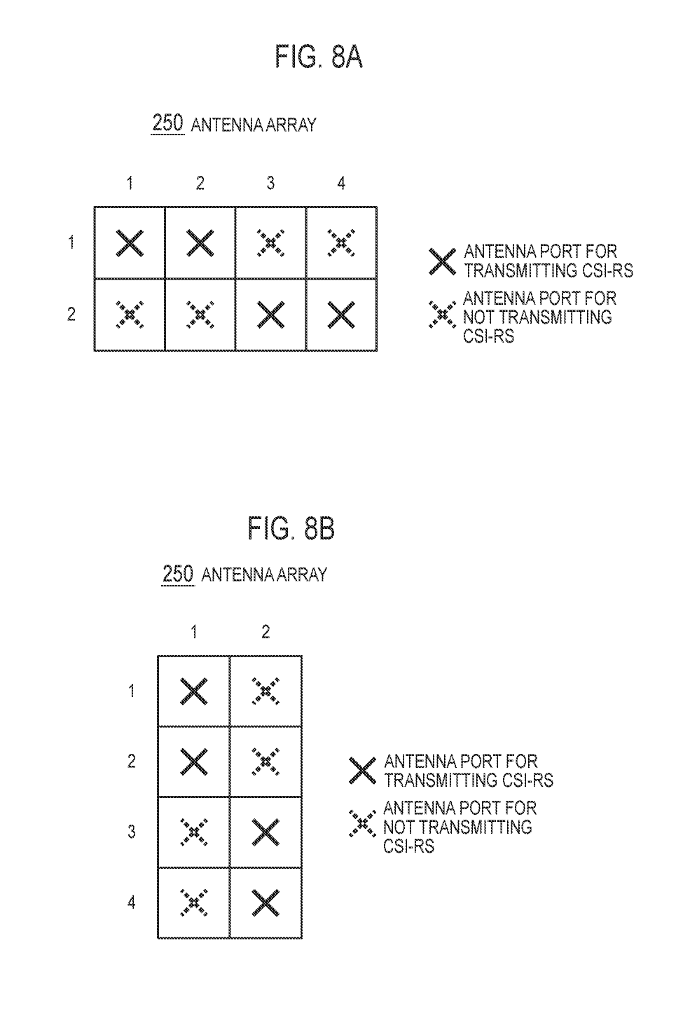

FIG. 8A illustrates another configuration example 1 of the antenna array 250, and FIG. 8B illustrates another configuration example 2 of the antenna array 250.

FIG. 8A exemplifies the antenna array 250 having two rows and four columns. In FIG. 8A, an antenna port (1, 1), an antenna port (1, 2), an antenna port (2, 3), and an antenna port (2, 4) are the specific antenna ports.

FIG. 8B exemplifies the antenna array 250 having four rows and two columns. In FIG. 8B, an antenna port (1, 1), an antenna port (2, 1), an antenna port (3, 2), and an antenna port (4, 2) are the specific antenna ports.

In this manner, the antenna array 250 according to the first embodiment is provided with at least one specific antenna port on each row and each column of the antenna array 250. Only some antenna ports in each row of the antenna array 250 are the specific antenna ports, and only some antenna ports in each column of the antenna array 250 are the specific antenna ports.

For example, in FIG. 8A, when focusing on the first row, only two antenna ports (1, 1) and (1, 2) out of four antenna ports are the specific antenna ports, and when focusing on the second row, only two antenna ports (2, 3) and (2, 4) out of four antenna ports are the specific antenna ports. Furthermore, when focusing on the first column, only one antenna port (1, 1) out of two antenna ports is the specific antenna port; when focusing on the second column, only one antenna port (1, 2) out of two antenna ports is the specific antenna port; when focusing on the third column, only one antenna port (2, 3) out of two antenna ports is the specific antenna port; and when focusing on the fourth column, only one antenna port (2, 4) out of two antenna ports is the specific antenna port.

With the antenna array 250 according to the first embodiment, only some specific antenna ports out of all antenna ports of the antenna array 250 is simultaneously used to transmit the CSI-RS, and thus, an increase in overhead and processing complexity can be suppressed. Furthermore, at least one specific antenna port is arranged in each row and each column of the antenna array 250, and thus, the UE 100 can estimate the channel characteristics of each row (in the horizontal direction) and each column (in the vertical direction) at one time.

### Comparative Example

Here, a comparative example will be described to clarify benefits of the antenna array 250 according to the first embodiment.

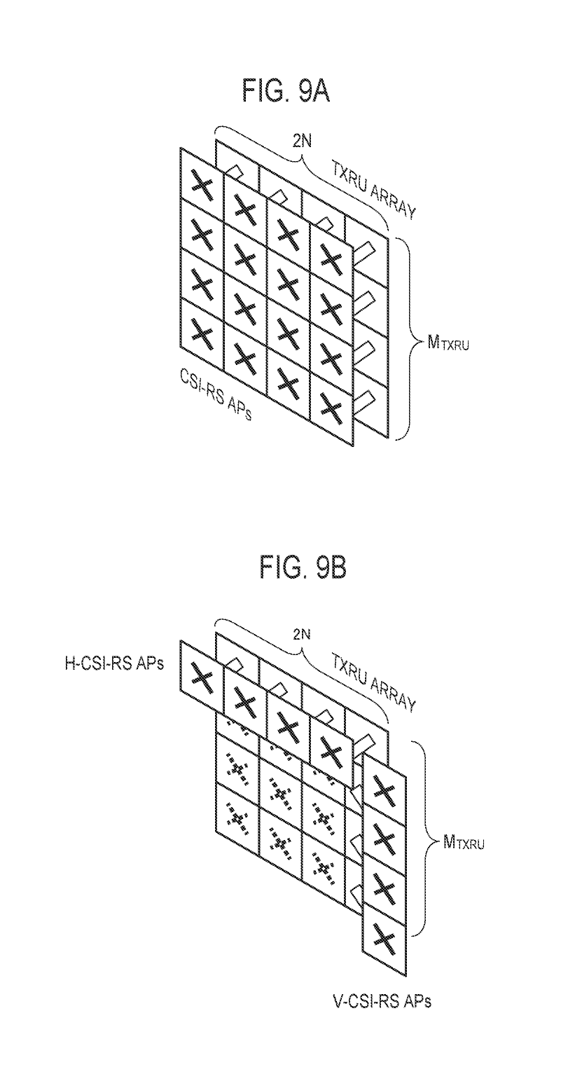

FIG. 9A is a diagram illustrating a comparative example 1. In the comparative example 1, CSI-RS antenna ports (CSI-RS Aps) are mapped to all antenna ports of “TXRU Array”. That is, the eNB 200 transmits a CSI-RS from all antenna ports of the “TXRU Array”. In the comparative example 1, an increase in overhead and processing complexity as described above occurs.

FIG. 9B is a diagram illustrating a comparative example 2. In the comparative example 2, CSI-RS antenna ports (H-CSI-RS Aps) A to D are mapped to all antenna ports of a first row of “TXRU Array”, and CSI-RS antenna ports (V-CSI-RS Aps) 0 to 3 are mapped to all antenna ports of a fourth column of the “TXRU Array”. The comparative example 2 can reduce the overhead compared to the comparative example 1.

First, in the comparative example 2, the eNB 200 first transmits a CSI-RS from one row of horizontal antenna ports (H-CSI-RS Aps) A to D for the estimating the horizontal channel characteristics, and the UE 100 estimates horizontal channel characteristics H_{V}. The channel characteristics H_{V} obtained here are only partial horizontal channel characteristics. Then, the UE 100 feeds the horizontal CSI (PMI and CQI) back to the eNB 200 according to the channel characteristics H_{H}.

Next, the eNB 200 transmits a CSI-RS from one column of vertical antenna ports (V-CSI-RS Aps) 0 to 3 for estimating the vertical channel characteristics, and the UE 100 measures vertical channel characteristics H_{V}. The channel characteristics H_{V} obtained here are only partial vertical channel characteristics. Then, the UE 100 feeds the vertical CSI (PMI and CQI) back to the eNB 200 according to the channel characteristics H_{V}.

The eNB 200 generates an (total) antenna weight or precoder obtained by combining a horizontal transmission precoder and a vertical precoder, based on the received horizontal PMI and vertical PMI. For example, a Kronecker product is used to combine the precoders. Then, the eNB 200 uses the antenna weight or the precoder obtained by the combination to control the downlink multi-antenna transmission.

However, in the comparative example 2, it is necessary to transmit a CSI-RS two times and to feed a CSI back two times, and thus, overhead equivalent to two times occurs. Furthermore, a certain time interval occurs, and thus, it is disadvantageous for a channel having a high-speed change. Furthermore, from the combination of the precoders, a mismatch occurs between a precoder used for an actual data transmission and the CSI (PMI) estimated by the UE 100, and it is also problematic in view of securing a performance.

It is noted that although a method of using, by the UE 100, the Kronecker product to calculate the total channel characteristics H in advance, and feeding back the CSI (PMI and CQI) corresponding to the H is also considered, the UE 100 may have disadvantages of increase in calculation load and complexity. Furthermore, the above-described problem of mismatch similarly exists.

(Operation According to First Embodiment)

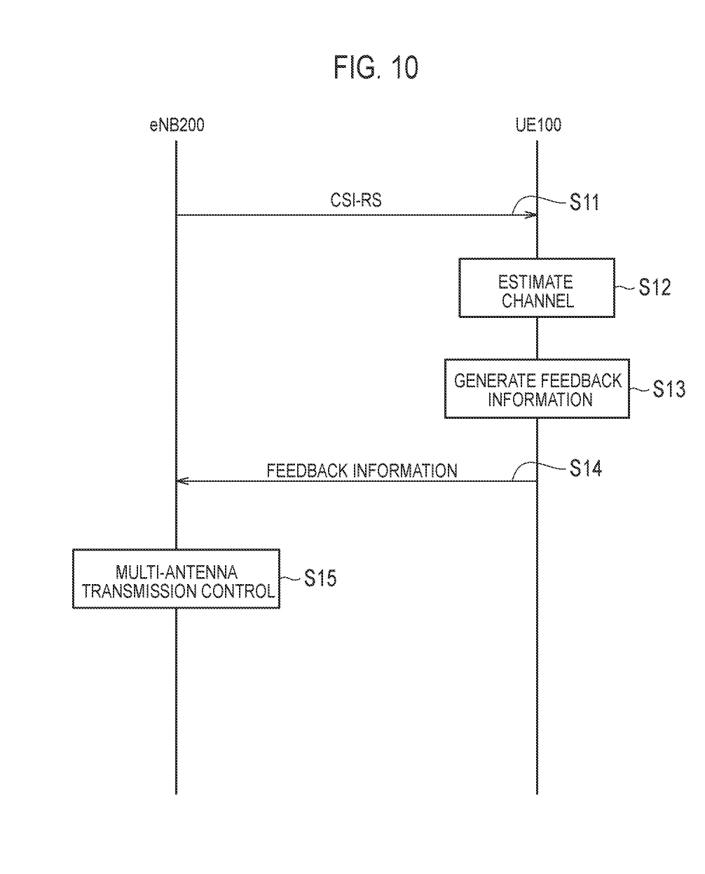

Hereinafter, an operation sequence using the antenna array 250 according to the first embodiment (see FIG. 7 and FIG. 8) will be described. FIG. 10 is a diagram illustrating an example of the operation sequence according to the first embodiment.

As illustrated in FIG. 10, in step S11, the transmitter 210 of the eNB 200 simultaneously uses specific antenna ports of the antenna array 250 to transmit a CSI-RS. The receiver 110 of the UE 100 receives the CSI-RS.

In step S12, the controller 130 of the UE 100 uses the CSI-RS to estimate channel characteristics of each specific antenna port. The channel characteristics estimated here are considered as total channel characteristics H in the horizontal direction and in the vertical direction.

In step S13, the controller 130 of the UE 100 generates CSI (feedback information) corresponding to the channel characteristics H.

In step S14, the transmitter 120 of the UE 100 transmits the CSI (feedback information) to the eNB 200. The receiver 220 of the eNB 200 receives the CSI.

In step S15, the controller 230 of the eNB 200 directly determines, based on the received CSI, a precoder for data transmission (PDSCH) without combining precoders as in the comparative example 2. Then, the controller 230 of the eNB 200 uses the determined precoder to control downlink multi-antenna transmission.

(Summary of First Embodiment)

According to the first embodiment, one CSI-RS transmission and one feedback is sufficient, and thus, overhead is less compared to the comparative example 2. Further, the conventional CSI feedback specifications can also be diverted. Furthermore, it can correspond to a high-speed channel.

In the first embodiment, the UE 100 and the eNB 200 have no complex calculation. Furthermore, the CSI fed back by the UE 100 can be directly applied to the eNB 200, and thus, a problem of mismatch as in the comparative example 2 does not occur.

### Second Embodiment

A second embodiment will be described while focusing on differences from the first embodiment, below. In the second embodiment, a case is assumed where the channel characteristics of all antenna ports are required.

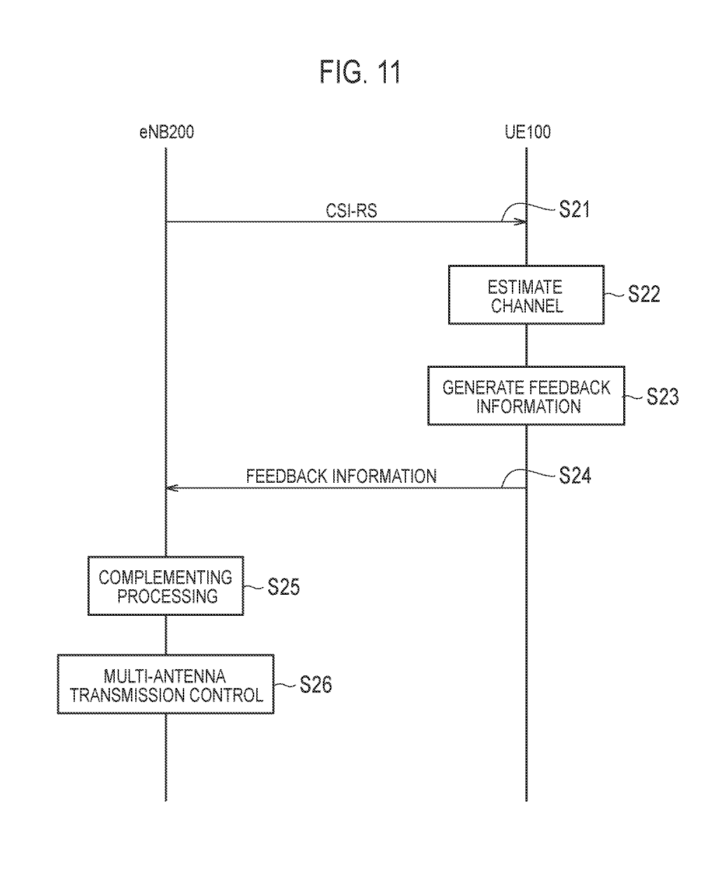

FIG. 11 is a diagram illustrating an example of an operation sequence according to the second embodiment.

As illustrated in FIG. 11, steps S21 to S24 are the same as those in the first embodiment.

In step S25, the controller 230 of the eNB 200 performs, based on the received CSI (feedback information), complementing processing for complementing channel characteristics corresponding to an antenna port other than the specific antenna ports in the antenna array 250.

In step S26, the controller 230 of the eNB 200 determines a precoder for data transmission (PDSCH) based on a result of the complementing processing, and uses the determined precoder to control the downlink multi-antenna transmission.

In this manner, the complementing processing according to the second embodiment is performed, based on the CSI (feedback information) fed back one time for the one transmission of the CSI-RS. This is different from the comparative example 2 in which the complementing processing is performed based on the CSI fed back two times for two transmissions of the CSI-RS.

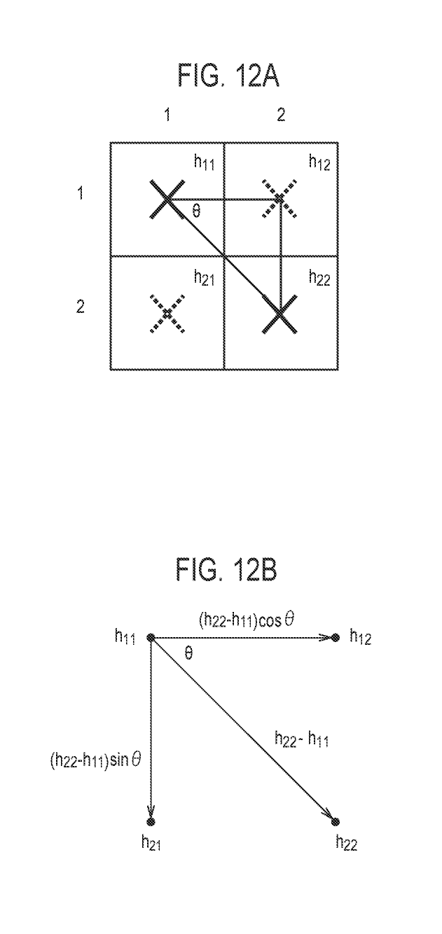

FIGS. 12A and 12B are diagrams for describing an example of the complementing processing indicated in step S25 in FIG. 11. Here, it is assumed that the antenna array 250 having two rows and two columns is used. In FIGS. 12A and 12B, the notations of h₁₁, h₁₂, h₂₁, and h₂₂ simultaneously represent the location of an antenna port (including a theoretical location) and channel characteristics corresponding to the port.

As illustrated in FIG. 12A, antenna ports (1, 1) and (2, 2) are the specific antenna ports. The channel characteristics h₁₁ and h₂₂ corresponding to the antenna ports (1, 1) and (2, 2) can be estimated by using the CSI-RS of the location thereof.

The eNB 200 uses the channel characteristics h₁₁ and h₂₂ to complement (extrapolate) the channel characteristics h₁₂ and h₂₁ corresponding to the antenna ports (1, 2) and (2, 1) as described below. In the complementing processing, information on a physical amount θ of the antenna array and the location of the specific antenna port for transmitting the CSI-RS is required.

First, a difference between h₂₂ and h₁₁ is calculated (h₂₂−h₁₁). It is noted that h₁₁ and h₂₂ are complex numbers, and it is understood as a vector on a complex plane as illustrated in FIG. 12B.

Then, h₁₂ and h₂₁ are calculated as follows.

h₁₂=h₁₁+(h₂₂−h₁₁)cos θ

h₂₁=h₂₂−(h₂₂−h₁₁)cos θ

This formula is used to calculate h₁₂ and h₂₁ by using a correction amount (h₂₂−h₁₁) cosθ in the horizontal direction, based on h₁₁ and h₂₂. On the other hand, h₁₂ and h₂₁ can also be calculated by using a correction amount (h₂₂−h₁₁) sinθ in the vertical direction, based on h₁₁ and h₂₂, as follows:

h₁₂=h₂₂−(h₂₂h−h₁₁)sin θ

h₂₁=h₁₁+(h₂₂−h₁₁)sin θ

In the above formula, h₁₁ and h₂₂ are actually estimated channel characteristics, and are assumed to be correct values if ignoring an estimated error. On the other hand, (h₂₂−h₁₁) cosθ and (h₂₂−h₁₁) sinθ are the correction amounts for the measured values, where a smaller correction is desirable. Thus, based on θ=45°, the above-described formula will be used as described below:

If θ≧45°(θ≦90°), (that is, if h₁₁ is closer to h₁₂ than h₂₂, and h₂₂ is closer to h₂₁ than h₁₁)

h₁₂=h₁₁+(h₂₂−h₁₁)cos θ

h₂₁=h₂₂−(h₂₂−h₁₁)cos θ

If θ<45°(θ≧0°)

h₁₂=h₂₂−(h₂₂−h₁₁)sin θ

h₂₁=h₁₁+(h₂₂−h₁₁)sin θ

Then, values of cos, or sinθ (hereinafter, referred to as “correction coefficient” for convenience) can be kept to be √2/2 or less. Although the correction coefficient can be set to be smaller, there is a problem of a vacant space of θ occurring. For example, if θ is calculated by being divided in 60° or more, or 30° or less, the correction coefficient can be 0.5 or less, but a vacant space occurs between 30° to 60°.

Even if the complement formula is calculated in two steps based on θ=45° as described above, a maximum of √2/2 of the correction coefficient value occurs, and thus, if a smaller correction amount is desirable, a method of compressing the correction amount is considered as follows.

h₁₂=h₁₁+(h₂₂−h₁₁))cos² θ

h₂₁=h₂₂−(h₂₂−h₁₁)cos² θ

In the above case, the correction coefficient can be equivalently kept to be 0.5 or less.

It is noted that the eNB 200 can use the same method for complementing even if the antenna array 250 is larger than two rows and two columns. This case has two or more estimated values, and thus, it is desirable to use at least two closest correct values for the complement when calculating for the complement.

### Third Embodiment

A third embodiment will be described while focusing on differences from the first embodiment and the second embodiment, below. The third embodiment is common with the second embodiment in that the complementing processing is performed, but differs from the second embodiment in that the complementing processing is performed on the UE 100 side.

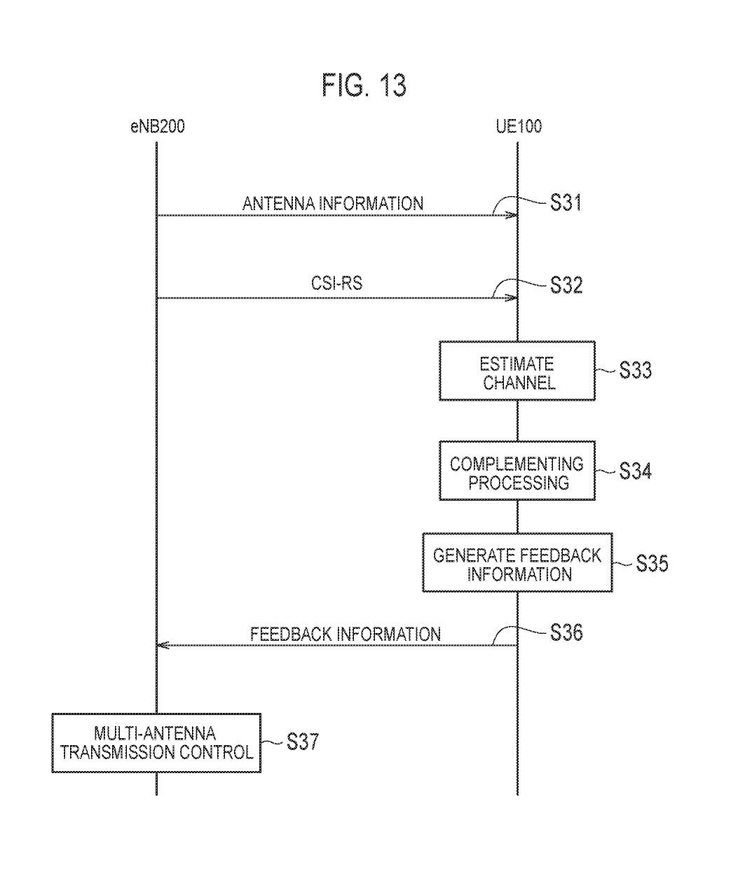

FIG. 13 is a diagram illustrating an example of an operation sequence according to the third embodiment.

As illustrated in FIG. 13, in step S31, the transmitter 210 of the eNB 200 transmits information related to the antenna array 250 (antenna information) to the UE 100. The antenna information is information on the above-described θ of the antenna array, the location of the specific antenna port, and the like. The information on the location of the specific antenna port may be information indicating an arrangement pattern of the specific antenna port. Furthermore, the antenna information may include information indicating a row and a column at which the antenna array 250 is located, information indicating an interval between antenna ports, and the like. Alternatively, the antenna information may be an index indicating information on θ of the antenna array and/or the location of the specific antenna port. The receiver 110 of the UE 100 receives the antenna information and utilizes the antenna information in the complementing processing of step S34.

In step S32, the transmitter 210 of the eNB 200 simultaneously uses the specific antenna ports of the antenna array 250 to transmit a CSI-RS. The receiver 110 of the UE 100 receives the CSI-RS.

In step S33, the controller 130 of the UE 100 uses the CSI-RS to estimate channel characteristics of each specific antenna port. The channel characteristics estimated here are considered as total channel characteristics H in the horizontal direction and in the vertical direction.

In step S34, the controller 130 of the UE 100 performs, based on the channel characteristics H, complementing processing for complementing the channel characteristics corresponding to an antenna port other than the specific antenna ports in the antenna array 250. The controller 130 of the UE 100 may perform one complementing processing for one transmission of the CSI-RS. The method of the complementing processing is the same as that of the second embodiment.

In step S35, the controller 130 of the UE 100 generates CSI (feedback information) corresponding to the channel characteristics H after the complement.

In step S36, the transmitter 120 of the UE 100 transmits the CSI (feedback information) to the eNB 200. The receiver 220 of the eNB 200 receives the CSI.

In step S37, the controller 230 of the eNB 200 determines a precoder for data transmission (PDSCH), based on the received CSI, and uses the determined precoder to control downlink multi-antenna transmission.

### Other Embodiments

The complementing processing according to the above-described second embodiment and third embodiment may be modified as follows. First, in the CSI-RS arrangement as illustrated in FIG. 7, the channel characteristics H estimated for the CSI-RS is assumed to be the horizontal channel characteristics. Next, the channel characteristics H estimated for the CSI-RS is assumed to be the vertical channel characteristics. Furthermore, the channel characteristics assumed to be the horizontal channel characteristics and the vertical channel characteristics are combined by the Kronecker product, and calculated as the total channel characteristics.

In the above-described first embodiment to third embodiment, an example in which the present application is applied to the downlink multi-antenna transmission is described. However, the present application may be applied to uplink multi-antenna transmission. In the uplink multi-antenna transmission, the UE 100 may have the antenna array 250.

In the above-described first embodiment to third embodiment, the LTE system is exemplified as the radio communication system. However, the present application is not limited to the LTE system. The present application may be applied to the radio communication system other than the LTE system.

### Appendix

(1. Introduction)

At the RANI #80 meeting, the following agreements are made:
“High level categories” (sections for the TR) agreed in principle:
Potential CSI-RS and feedback enhancements
Enhancements related to beamformed CSI-RS-based schemes
Enhancements related to non-precoded CSI-RS-based schemes
Enhancements related to schemes based on hybrid beamformed CSI-RS and non-precoded CSI-RS
Enhancements related to non-codebook based CSI reporting for TDD
Enhancements related to SRS

In this appendix considerations on non-precoded CSI-RS based schemes are discussed.

(2. Non-precoded CSI-RS)

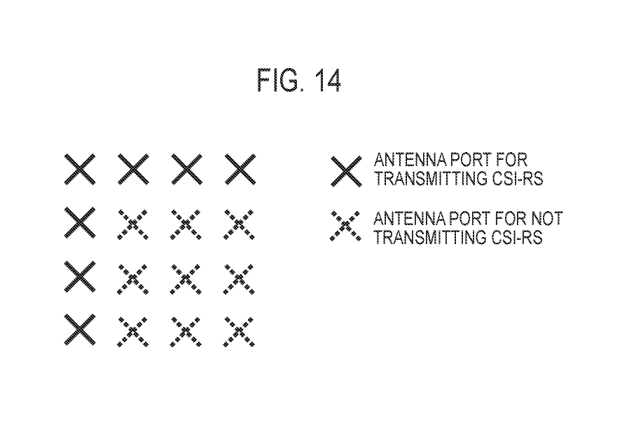

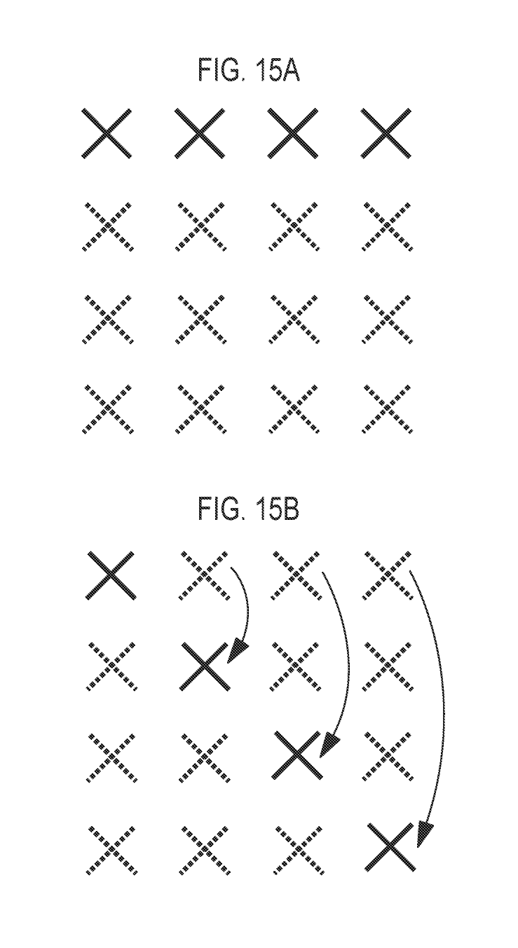

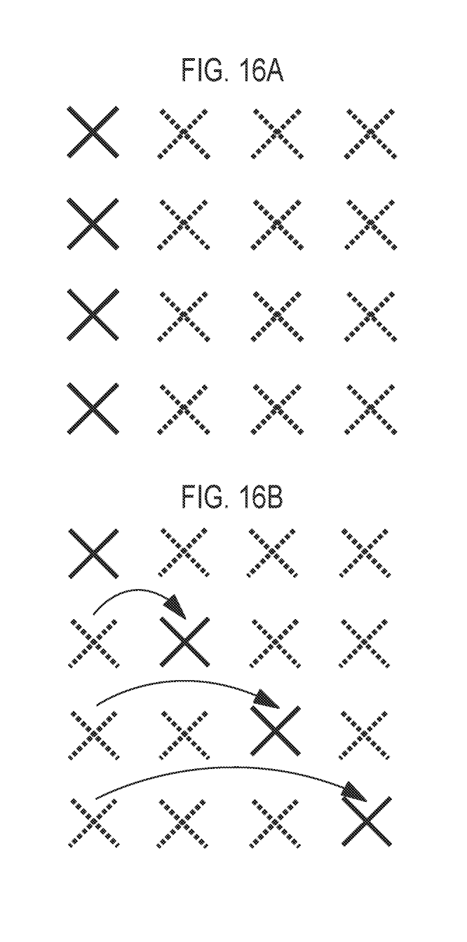

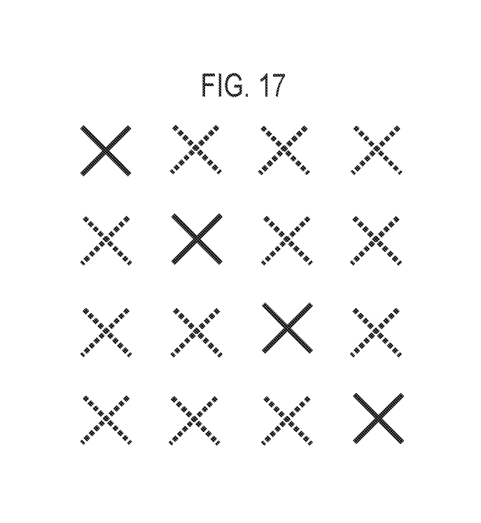

Besides transmitting full CSI-RS over all TXRUs, the most straightforward non-precoded CSI-RS based enhancement scheme is to transmit CSI-RS over a row of antenna array elements (here, we mean TXRU) for measuring the horizontal channel, and over a column of TXRUs for estimating the vertical channel as shown in FIG. 14. The UE is configured with two CSI processes. One CSI process is used for reporting the horizontal CSI and the other one is for feeding back the vertical CSI. Note that for convenience sake and without loss of generality, in this appendix, virtualization between TXRU and antenna elements is ignored, and it is assumed that the antenna array consists logically of TXRUs.

Observation 1: Separated horizontal and vertical CSI measurements and feedback needs two CSI processes, which causes more overhead.

At the eNB side, after receiving UE's the horizontal and vertical CSI information (PMI, CQI, etc.) report, a whole channel precoder needs to be generated for PDSCH, which can be achieved by for example using Kronecker product operation. However, since UE reported CSI are for separate horizontal and vertical channels, the eNB generated precoder may cause deviation from the expected performance. For extreme propagation environment, if exist, such a scheme may significantly degrade the performance. Extremely speaking, this scheme cannot guarantee the expected performance.

Observation 2: Separated horizontal and vertical CSI measurement and feedback may cause degradation in the performance.

(3. Consideration on Non-precoded CSI-RS ports mapping)

Based on the analysis in Section 2, the CSI-RS ports to TXRU mapping is considered. In the separated horizontal and vertical CSI measurement scheme, the CSI-RS ports used to estimate horizontal channel is mapped over a row of TXRU as shown in FIG. 2A. If we shift the mapped CSI-RS, we get a new mapping as shown in FIG. 2B. Although the shifted CSI-RS ports are not located at a row of TXRU, the measured results can be treated as the horizontal channel characteristics.

Now, applying the similar shift to CSI-RS ports used to estimate vertical channel as shown in FIG. 3.

Same with the FIG. 2 case, although the shifted CSI-RS ports are not located at a column of TXRU, the measured results are treated as the vertical channel characteristics.

Then, an interesting thing that the identical CSI-RS mapping as shown in FIG. 4 can be interpreted for both horizontal and vertical channel measurement is found. It is considered that the measurement results using the “new” CSI-RS ports mapping includes both CSI information for the horizontal and the vertical channel.

Observation 3: Channel measurement using specially designed CSI-RS mapping can simultaneously include whole channel CSI information, e.g., both the horizontal and the vertical channel CSI information.

Based on Observation 3, it can be understood that only one CSI process is enough to report CSI for 2DAAs. UE is configured only for one CSI process. The eNB transmits CSI-RS according to the mapping shown in FIG. 4. The UE measures the channel and reports CSI (PMI, CQI, RI) based on the measurement results. Note that it is not needed to emphasize what dimension channel characteristics are included in such a CSI report, instead, the CSI report represents, in some sense, the whole channel. Based on UE reported CSI, the eNB directly generate whole channel precoder without performing any additional operations for combining the horizontal and the vertical CSI separate reports.

Since only one CSI process is configured, it can be intuitively understood that overhead can be reduced. Moreover, since the UE reported CSI can be directly used to generate precoder for whole channel without other operations, e.g., Kronecker product, the performance degradation can be reduced. It is recognized that the CSI-RS port mapping pattern described here may not achieve the best performance since only partial channel is measured. Note this is also true for the separated horizontal and vertical CSI reports as well. However, with our approach the performance can be expected in advance without deviation, since the CSI UE report is applied to generate the required precoder without any additional operations.

Proposal: Specially designed CSI-RS port mapping pattern shall be studied to reduce the overhead.

### INDUSTRIAL APPLICABILITY

The present disclosure is useful in the field of communication.

1. A communication apparatus comprising:
an antenna array having antenna elements arranged in rows and columns, and
a transmitter configured to simultaneously use specific antenna elements that are some antenna elements out of all antenna elements of the antenna array to transmit a reference signal, wherein
at least one of the specific antenna elements is arranged in each row and each column of the antenna array.

2. The communication apparatus according to claim 1, wherein
only some antenna elements in each row of the antenna array are the specific antenna elements, and only some antenna elements in each column of the antenna array are the specific antenna elements.

3. The communication apparatus according to claim 1, wherein
the specific antenna elements are arranged on a diagonal line of the antenna array.

4. The communication apparatus according to claim 1, comprising:
a receiver configured to receive feedback information from another communication apparatus, and
a controller configured to perform complementing processing, based on the feedback information, wherein
the feedback information is information corresponding to channel characteristics estimated by the other communication apparatus for each of the specific antenna elements by using the reference signal, and
the complementing processing is processing of complementing channel characteristics corresponding to an antenna element other than the specific antenna elements in the antenna array.

5. The communication apparatus according to claim 4, wherein the controller performs the complementing processing, based on the feedback information fed back one time for one transmission of the reference signal.

6. A communication apparatus, comprising: a receiver configured to receive a reference signal transmitted from another communication apparatus having an antenna array, and
a controller configured to use the reference signal to estimate channel characteristics for each of specific antenna elements, wherein
the specific antenna elements are some antenna elements out of all antenna elements of the antenna array, and at least one of the specific antenna elements is arranged in each row and each column of the antenna array,
the other communication apparatus simultaneously uses the specific antenna elements to transmit the reference signal, and
the controller is configured to perform complementing processing for complementing channel characteristics corresponding to an antenna element other than the specific antenna elements in the antenna array to generate feedback information for the other communication apparatus.

7. The communication apparatus according to claim 6, wherein
the controller is configured to perform the complementing processing one time for one transmission of the reference signal.

8. The communication apparatus according to claim 6, wherein
the controller is configured to obtain information on the antenna array from the other communication apparatus, and uses the obtained information to perform the complementing processing.

9. A communication apparatus, comprising: an antenna array having antenna elements arranged in rows and columns,
a transmitter configured to simultaneously use specific antenna elements that are some antenna elements out of all antenna elements of the antenna array to transmit a reference signal, and
a controller configured to notify another communication apparatus of information on the antenna array, wherein
the information on the antenna array includes at least one of information indicating a physical amount of the antenna array and information indicating the location of each of the specific antenna ports.
